(19) United States
(12) Patent Application Publication
(10) Pub. No.: US 2010/0099417 A1
(43) Pub. Date: Apr. 22, 2010

(54) METHOD FOR MULTI-ZONE MANAGEMENT AND METHOD FOR HANDING OFF A MOBILE TERMINAL USING MULTI-ZONE MANAGEMENT

(75) Inventor: Sung-kew CHO, Seoul (KR)

Correspondence Address: H.C. PARK & ASSOCIATES, PLC, 8500 LEESBURG PIKE, SUITE 7500, VIENNA, VA, 22182, US

(73) Assignee: Pantech&Curitel Communications, Inc., Seoul (KR)

(21) Appl. No.: 12/535,204

(22) Filed: Aug. 4, 2009

(30) Foreign Application Priority Data
Oct. 22, 2008 (KR) 10-2008-0103694

(51) Int. Cl. H04W 36/00

(52) U.S. Cl. 455/443

(57) ABSTRACT

In a multi-zone management method of a mobile terminal and a handoff method of the mobile terminal using multi-zone management, the mobile terminal records or deletes zone identification information in or from a base station table managed for a handoff, and the zone identification information is used as information for preventing a mobile terminal from frequently registering to a new base station due to frequent handoffs in an overlapping area of two base stations.

### CROSS-REFERENCE TO RELATED APPLICATION

This application claims priority from and the benefit of Korean Patent Application No. 10-2008-103694, filed on Oct. 22, 2008, which is hereby incorporated by reference for all purposes as if fully set forth herein.

### BACKGROUND OF THE INVENTION

1. Field of the Invention

The following description relates to a handoff technology of a mobile terminal, and more particularly, to a method for multi-zone management of a mobile terminal and a method for handing off a mobile terminal using multi-zone management.

2. Discussion of the Background

As a mobile terminal registered in a present base station moves closer to a new base station, a signal from the new base station becomes stronger in strength, and a signal from the present base station may become weaker. Thus, to maintain a currently connected call, the mobile terminal hands off from the present base station to the new base station. In the middle area of the two base stations, signals of the two base stations may be almost equal in strength to each other, and thus, the mobile station can connect a call to any of the two base stations, and at this time, a handoff procedure is performed.

A handoff is initiated by the mobile terminal. That is, a point of time when a handoff is performed is determined by the mobile terminal. Since the mobile terminal has to continuously consider an approach to neighboring base stations, it has to search for signal strength of pilot channels of the neighboring base stations.

This process is called pilot searching. The pilot searching is continuously performed while a mobile terminal is on, that is, in an idle state or in an active state, regardless of whether or not a call is connected. Here, the idle state includes a general standby state in which a Point-to-Point Protocol (PPP) session is released and a dormant state in which a PPP session is connected.

However, in the middle area (i.e., an overlapping area) of the two base stations, since signals of the two base station are almost equal in strength to each other, a handoff may be more frequently performed as the mobile terminal moves within the overlapping area. Thus, the mobile station has to register with a new base station at every handoff, leading to communication resource waste.

A technique for preventing a mobile terminal from frequently registering to a new base station due to frequent handoffs in the overlapping area of two base stations is therefore needed to prevent communication resource waste.

### SUMMARY OF THE INVENTION

Exemplary embodiments of the present invention provide a method for multi-zone management in which a mobile terminal records or deletes zone identification (ID) information in or from a base station table managed for a handoff, and the zone ID information is used as information for preventing a mobile terminal from frequently registering to a new base station due to frequent handoffs in an overlapping area of two base stations.

Exemplary embodiments of the present invention also provide a method for handing off a mobile terminal using multi-zone management in which radio resource waste may be reduced by preventing a mobile terminal from frequently registering to a new base station due to frequent handoffs in an overlapping area of two base stations.

Additional features of the invention will be set forth in the description which follows, and in part will be apparent from the description, or may be learned by practice of the invention.

An exemplary embodiment of the present invention discloses a method for multi-zone management by handing off from a previous base station to a present base station and then receiving zone identification information of the present base station from the present base station; determining if the zone identification information of the present base station is registered in a base station table managed for a handoff; recording the zone identification information of the present base station in the base station table if the zone identification information of the present base station is not registered in the base station table; and informing a mobile communication system that a mobile terminal is located in an overlapping area of the present base station and the previous base station to perform a multi-zone registration after recording the zone identification information of the present base station in the base station table.

An exemplary embodiment of the present invention also discloses a method for multi-zone management by handing off from a previous base station to a present base station; determining whether signal strength detected from the previous base station is equal to or less than a predetermined value; deleting zone identification information of the previous base station from a base station table managed for a handoff if the signal strength detected from the previous base station is equal to or less than the predetermined value; and informing a mobile communication system that a mobile terminal is located in an area other than an overlapping area of the present base station and the previous base station to perform a zone re-registration after deleting the zone identification information of the previous base station from the base station table.

An exemplary embodiment of the present invention also discloses a method for handing off a mobile terminal using multi-zone management by determining if a mobile terminal is located within a multi-zone registration area when handing off from a present base station to a target base station; and handing off from the present base station to the target base station without registering to the target base station if the mobile terminal is located within the multi-zone registration area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows zones managed through a method for multi-zone management according to an exemplary embodiment of the present invention.

FIG. 2 shows an example of a base station table managed through a method for multi-zone management according to an exemplary embodiment of the present invention.

FIG. 3 is a flowchart illustrating a method for multi-zone management according to an exemplary embodiment of the present invention.

FIG. 4A and FIG. 4B are flowcharts illustrating a method for multi-zone management according to an exemplary embodiment of the present invention.

FIG. 5 is a flowchart illustrating a method for handing off a mobile terminal using multi-zone management according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the sizes and relative sizes of layers and regions may be exaggerated for clarity. Like reference numerals in the drawings denote like elements.

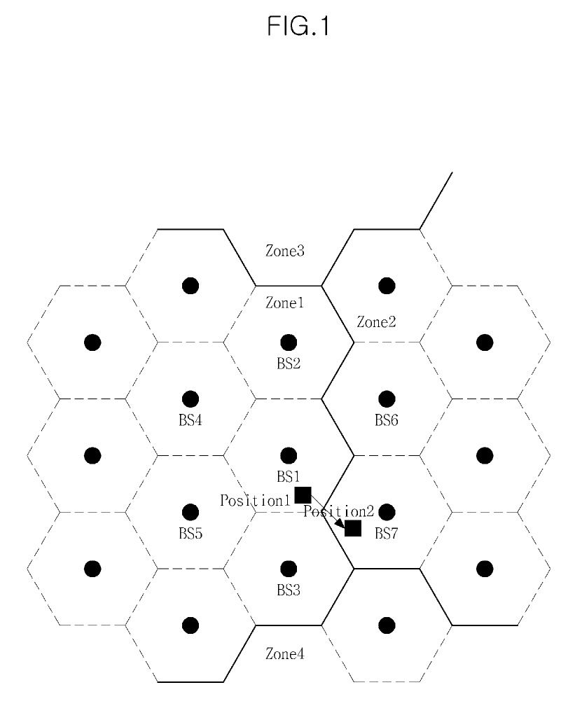

FIG. 1 shows zones managed through a method for multi-zone management according to an exemplary embodiment of the present invention. According to an exemplary embodiment, “zone” is defined as a unit which a mobile communication system uses to page a mobile terminal, and each zone may include one or more base stations and is assigned specific zone identification (ID) information.

Referring to FIG. 1, four zones 1 to 4 are defined using zone ID information. Base stations (BSs) 1 to 5 belong to zone 1, and base stations 6 and 7 belong to zone 2.

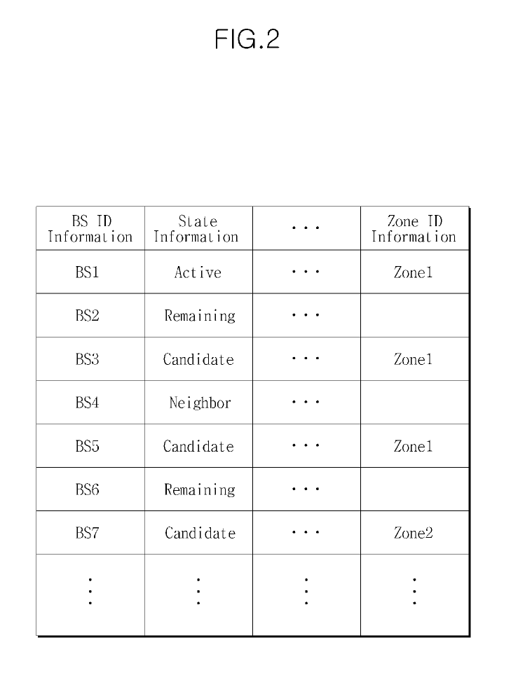

FIG. 2 shows an example of a base station table managed through a method for multi-zone management according to an exemplary embodiment of the present invention. For a handoff, a mobile terminal monitors signal strength of pilot channels of neighboring base stations and stores base station states in a base station table managed by a mobile terminal for a handoff.

Base station ID information and state information are commonly recorded in the base station table managed by a mobile terminal for a handoff. The base station ID information is information specific to a base station and is used to identify a base station, and the state information depends on signal strength of pilot channels of base stations.

The state information is classified into an active set, a candidate set, a neighbor set, and a remaining set. A base station which has assigned a traffic channel to a mobile terminal is classified as the active set. A base station which does not belong to the active set but has sufficient signal strength is classified as the candidate set. A base station which belongs to neither the active set nor the candidate set but may be considered a candidate for a handoff is classified as the neighbor set. A base station which does not belong to any of the other sets is classified as the remaining set.

As shown in FIG. 2, according to the method for multi-zone management according to an exemplary embodiment, zone ID information is further managed in addition to the state information described above. The state information and the zone ID information of base stations shown in FIG. 1 will be described below with reference to FIG. 2. It can be seen from FIG. 2 that zone ID information of base stations which belong to the active set and the candidate set is recorded, while zone ID information of base stations which belong to the neighbor set and the remaining set is deleted.

A mobile terminal records or deletes zone ID information in or from a base station table managed for a handoff and uses zone ID information to prevent a mobile terminal from frequently registering to a new base station due to frequent handoffs in an overlapping area of two base stations, thereby reducing the risk of radio resource waste.

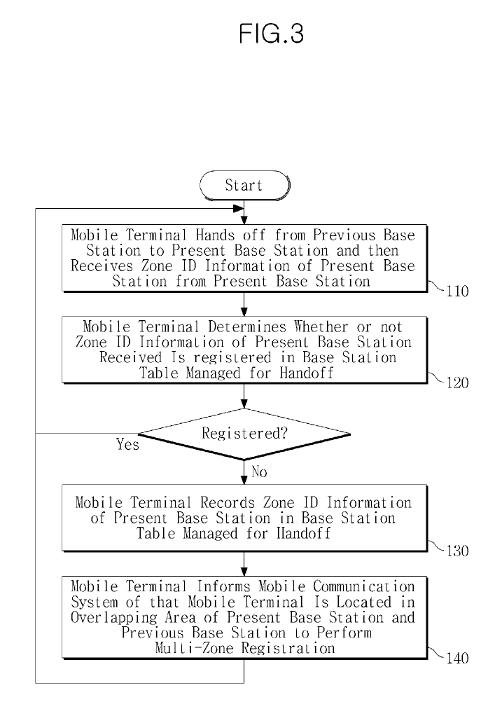

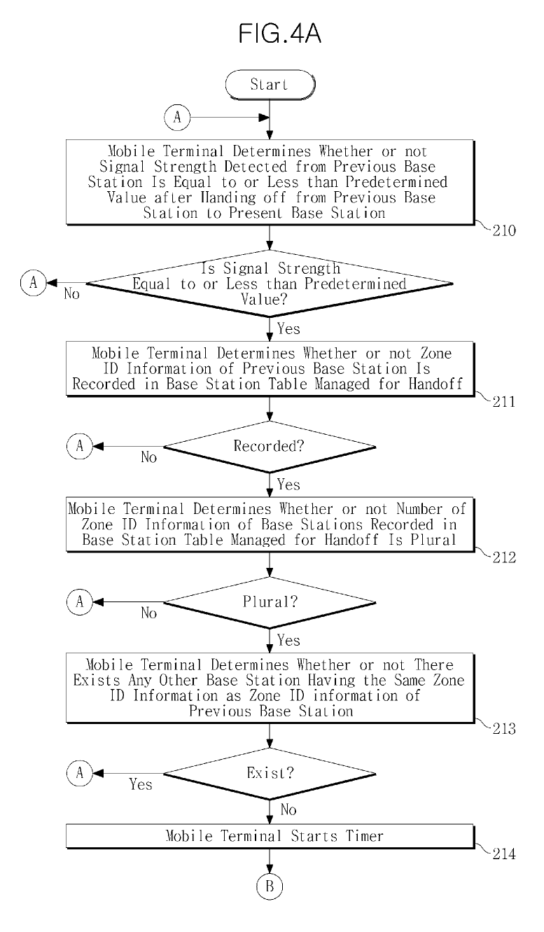

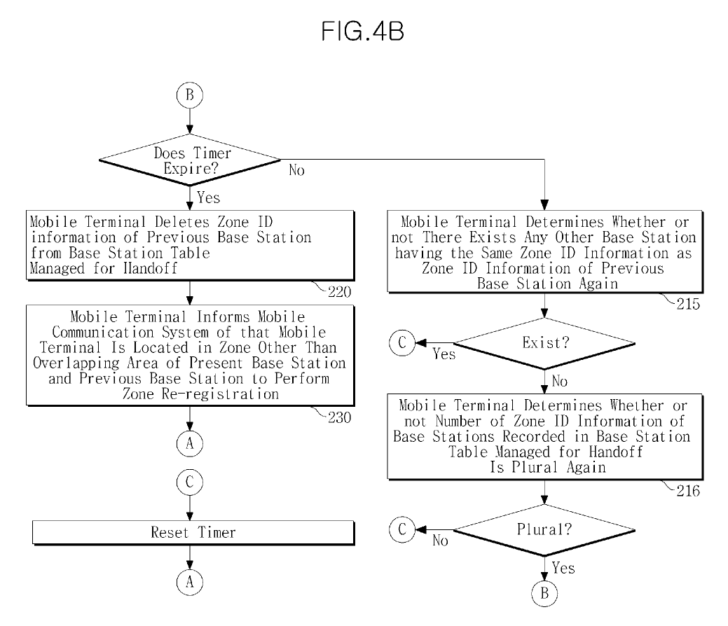

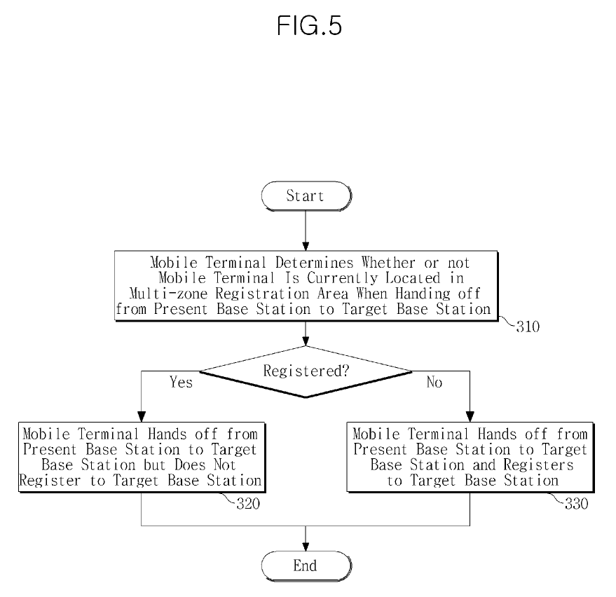

A method for multi-zone management and a method for handing off a mobile terminal in which zone ID information is recorded in or deleted from a base station table managed for a handoff by a mobile terminal will be described below in more detail with reference to FIG. 3, FIG. 4, and FIG. 5.

FIG. 3 is a flowchart illustrating a method for multi-zone management according to an exemplary embodiment of the present invention. FIG. 3 shows an embodiment of an operation in which a mobile terminal records zone ID information in a base station table managed for a handoff and performs multi-zone registration.

Referring to FIG. 3, a mobile terminal hands off from a previous base station to a present base station and then receives zone ID information of the present base station from the present base station 110.

The mobile terminal hands off from a base station 1 belonging to zone 1 to a base station 7 belonging to zone 2. When the mobile terminal hands off from base station 1, which is the previous base station, to base station 7, which is the present base station, the mobile terminal receives zone 2 as zone ID information from base station 7, which is the present base station.

Then, the mobile station determines whether or not the zone ID information of the present base station received in operation 110 is already registered in the base station table managed for a handoff 120.

When it is determined in operation 120 that the zone ID information of the present base station is already registered in the base station table managed for a handoff, the procedure returns to the initial stage since this means that a multi-zone registration has already been performed.

When it is determined in operation 120 that the zone ID information of the present base station is not registered in the base station table managed for a handoff, the mobile terminal records the zone ID information of the present base station in the base station table managed for a handoff 130.

After recording the zone ID information of the present base station in the base station table managed for a handoff in operation 130, the mobile terminal informs a mobile communication system that the mobile terminal is located in the overlapping area of the present base station and the previous base station to perform a multi-zone registration 140.

At this time, in operation 140, the mobile terminal stores multi-zone registration information, including the zone ID information of the present base station and zone ID information of the previous base station, and transmits the multi-zone registration information, including the zone ID information of the previous base station, to the mobile communication system to perform the multi-zone registration.

Therefore, zone ID information is recorded in a base station table managed for a handoff and used as information for preventing the mobile station from frequently registering to a new base station due to frequent handoffs in an overlapping area of two base stations.

FIG. 4A and FIG. 4B are flowcharts illustrating a method for multi-zone management according to an exemplary embodiment of the present invention. FIG. 4A and FIG. 4B show an embodiment of an operation in which a mobile terminal deletes zone ID information from a base station table managed for a handoff to perform a zone re-registration.

As shown in FIG. 4A and FIG. 4B, the mobile terminal hands off from a previous base station to a present base station and then determines whether signal strength detected from the previous base station is equal to or less than a predetermined value 210.

When it is determined in operation 210 that signal strength detected from the previous base station is larger than the predetermined value, the procedure returns to the initial stage since it means that the mobile terminal is located in the overlapping area of the two base stations.

Before operation 220, shown in FIG. 4B, in which the zone ID information of the previous base station is deleted from the base station table managed for a handoff, the mobile station determines whether the zone ID information of the previous base station is recorded in the base station table managed for a handoff 211.

If the zone ID information of the previous base station is not recorded in the base station table managed for a handoff, this means either that the mobile terminal has already left the overlapping area of the two base stations and the zone ID information of the previous base station is deleted from the base station table managed for a handoff, or that the mobile station is not approaching the overlapping area of the two base stations, and thus this operation is performed to determine whether to continuously perform the following processes.

When it is determined in operation 211 that the zone ID information of the previous base station is recorded in the base station table managed for a handoff, the mobile station determines whether or not the number of zone ID information recorded in the base station table managed for a handoff is plural 212.

In the case where only one zone ID information is recorded in the base station table managed for a handoff, if the zone ID information is deleted, an error may occur when the mobile terminal re-enters the overlapping area later. In order to prevent the error, the mobile terminal determines whether the number of zone ID information recorded in the base station table managed for a handoff is singular.

When it is determined in operation 211 that zone ID information of the previous base station is not recorded in the base station table managed for a handoff, this means either that the mobile terminal has already left the overlapping area of the two base stations and the zone ID information of the previous base station is deleted from the base station table managed for a handoff, or that the mobile station is not approaching the overlapping area of the two base stations, and thus, the mobile terminal returns to the initial stage.

When it is determined in operation 212 that the number of zone ID information recorded in the base station table managed for a handoff is plural, the mobile terminal determines whether or not there are any other base stations which have the same zone ID information as the zone ID information of the previous base station 213.

If there is another base station which has the same zone ID information as the zone ID information of the previous base station, this means that the mobile terminal has not completely left the overlapping area of the two base stations, and thus, an operation is performed to investigate whether or not the mobile terminal has completely left the overlapping area.

When it is determined in operation 212 that the number of zone ID information recorded in the base station table managed for a handoff is not plural, that is, in the case in which only zone ID information of the previous base station is recorded, the procedure returns to the initial stage since if zone ID information of the previous base station is deleted, an error may occur when the mobile terminal re-enters the overlapping area later.

When it is determined in operation 213 that there are no other base stations which have the same zone ID information as the zone ID information of the previous base station, the mobile terminal starts a timer 214.

If there are no other base stations which have the same zone ID information as the zone ID information of the previous base station, this means that the mobile terminal has just recently left the overlapping area of the two base stations, and thus the mobile terminal starts the timer to investigate whether or not the mobile terminal re-enters the previous base station.

When it is determined in operation 213 that there is another base station which has the same zone ID information as the zone ID information of the previous base station, the procedure returns to the initial stage because this means that the mobile terminal has not completely left the overlapping area of the two base stations.

According to another exemplary embodiment, when the timer started in operation 214 expires, the mobile terminal performs operation 220 in which the zone ID information of the previous base station is deleted from the base station table managed for a handoff.

Since the timer is started in order to investigate whether or not the mobile terminal re-enters the previous base station when the mobile terminal has just recently left the overlapping area of the two base stations, expiration of the timer means that the mobile terminal has not re-entered the previous base station and has completely left the overlapping area of the two base stations, so that the mobile terminal performs an operation for deleting zone ID information managed for a handoff.

When the timer started in operation 214 does not expire, the mobile terminal determines again whether or not there are any other base stations having the same zone ID information as the zone ID information of the previous base station 215.

By determining whether or not the mobile terminal re-enters the previous base station when the timer has not expired, when the mobile terminal leaves and then re-enters the overlapping area of the two base stations, following processes can be performed.

When it is determined in operation 215 that there is another base station having the same zone ID information as the zone ID information of the previous base station, the timer is reset, and the procedure returns to the initial stage.

That is, when the mobile terminal leaves and then re-enters the overlapping area of the two base stations, the timer is reset, and the procedure returns to the initial stage.

When it is determined in operation 215 that there are no other base stations having the same zone ID information as the zone ID information of the previous base station, the mobile terminals determines again whether or not the number of zone ID information recorded in the base station table managed for a handoff is plural 216.

When the mobile terminal leaves and then does not re-enter the overlapping area of the two base stations, the mobile terminals determines whether or not the number of zone ID information recorded in the base station table managed for a handoff is singular.

When it is determined in operation 216 that the number of zone ID information recorded in the base station table managed for a handoff is not plural, that is, in the case in which only one zone ID information is recorded in the base station table managed for a handoff, in instances when zone ID information is deleted, an error may occur when the mobile terminal re-enters the overlapping area later. Therefore, the timer is reset, and the procedure returns to the initial stage.

When it is determined in operation 216 that the number of zone ID information recorded in the base station table managed for a handoff is plural, this means that the mobile terminal is located in an area other than the overlapping area, and thus the timer continuously operates.

When the timer continuously operates and then expires, since it is determined that the mobile terminal has not re-entered the previous base station and is located in an area other than the overlapping area of the two base stations, the mobile terminal may perform an operation for deleting zone ID information from the base station table managed for a handoff. Therefore, the mobile terminal deletes zone ID information from the base station table managed for a handoff.

One or more of the operations 211, 212, 213, and 214 may be excluded from the method for multi-zone management of a mobile terminal in proceeding from operation 210 to operation 220.

A handoff operation of a mobile terminal in a multi-zone area managed as described above will be described below with reference to FIG. 5. FIG. 5 is a flowchart illustrating a handoff method of a mobile terminal using multi-zone management according to an exemplary embodiment of the present invention.

The mobile terminal determines whether the mobile terminal is currently located within the multi-zone registration area when handing off from a present base station to a target base station 310. That is, since the mobile terminal has multi-zone registration information including zone ID information of the present base station and zone ID information of the previous base station therein, the mobile station compares zone ID information of the target base station transmitted from the target base station with multi-zone registration information to determine whether or not the mobile terminal is currently located in the multi-zone registration area.

When it is determined in operation 310 that the mobile terminal is located within the multi-zone registration area, the mobile terminal hands off from the present base station to the target base station but does not register to the target base station 320.

However, when it is determined in operation 310 that the mobile terminal is not located within the multi-zone registration area, the mobile terminal hands off from the present base station to the target base station and registers the target base station 330.

As apparent from the above description, when a mobile terminal is located within a multi-zone registration area, that is, when the mobile terminal is located in an overlapping area of two base stations and frequently performs a handoff between two base stations, the mobile terminal can prevent itself from frequently registering to a new base station using multi-zone registration information which is managed by recording or deleting zone ID information in or from a base station table managed for a handoff, and thus radio resource waste may be reduced.

Exemplary embodiments of the present invention can be applied to a handoff technology of a mobile terminal and an application technology thereof.

Exemplary embodiments of the present invention can be implemented as computer readable codes in a computer readable record medium that, when executed, perform a method such as the methods described above with reference to FIG. 4A and FIG. 4B, or FIG. 5. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A mobile terminal records or deletes zone ID information in or from a base station table managed for a handoff, and the zone ID information is used as information for preventing a mobile terminal from frequently registering to a new base station due to frequent handoffs in the overlapping area of two base stations, and thus radio resource waste may be reduced.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method for multi-zone management, comprising:
handing off from a previous base station to a present base station and then receiving zone identification information of the present base station from the present base station;
determining if the zone identification information of the present base station is registered in a base station table managed for a handoff;
recording the zone identification information of the present base station in the base station table if the zone identification information of the present base station is not registered in the base station table; and
informing a mobile communication system that a mobile terminal is located in an overlapping area of the present base station and the previous base station to perform a multi-zone registration after recording the zone identification information of the present base station in the base station table.

2. The method of claim 1, wherein the mobile terminal stores multi-zone registration information in performing the multi-zone registration.

3. The method of claim 2, wherein the multi-zone registration information includes zone identification information of the present base station and zone identification information of the previous base station therein.

4. The method of claim 3, wherein the mobile terminal transmits the multi-zone registration information, including the zone identification information of the previous base station, to the mobile communication system.

5. A method for multi-zone management, comprising:
handing off from a previous base station to a present base station;
determining whether signal strength detected from the previous base station is equal to or less than a predetermined value;
deleting zone identification information of the previous base station from a base station table managed for a handoff if the signal strength detected from the previous base station is equal to or less than the predetermined value; and
informing a mobile communication system that a mobile terminal is located in an area other than an overlapping area of the present base station and the previous base station to perform a zone re-registration after deleting the zone identification information of the previous base station from the base station table.

6. The method of claim 5, further comprising determining if the zone identification information of the previous base station is recorded in the base station table.

7. The method of claim 6, further comprising, determining if the number of zone identification information of the base stations recorded in the base station table is plural if the zone identification information of the previous base station is recorded in the base station table.

8. The method of claim 7, further comprising determining if another base station having the same zone identification information exists in the base station table managed for a handoff which has the same zone identification information as the zone identification information of the previous base station if the number of zone identification information of the base stations recorded in the base station table is plural.

9. The method of claim 8, further comprising starting a timer if another base station having the same zone identification information as the zone identification information of the previous base station does not exist in the base station table managed for a handoff.

10. The method of claim 9, wherein deleting the zone identification information of the previous base station from the base station table is performed when the timer expires.

11. The method of claim 9, further comprising determining again if another base station exists in the base station table managed for a handoff which has the same zone identification information as the zone identification information of the previous base station if the timer has not expired.

12. The method of claim 9, wherein the timer is reset if another base station having the same zone identification information as the zone identification information of the previous base station exists in the base station table managed for a handoff and a procedure returns to an initial stage.

13. The method of claim 9, further comprising, determining again if the number of zone identification information of the base stations recorded in the base station table is plural if there is not another station that exists in the base station table managed for a handoff which has the same zone identification information as the zone identification information of the previous base station.

14. The method of claim 13, wherein the timer is reset if the number of zone identification information of the base stations recorded in the base station table is not plural and a procedure returns to an initial stage.

15. The method of claim 13, wherein the timer continuously operates if the number of zone identification information of the base stations recorded in the base station table is plural.

16. A method for handing off a mobile terminal using multi-zone management, comprising:
determining if a mobile terminal is located within a multi-zone registration area when handing off from a present base station to a target base station; and
handing off from the present base station to the target base station without registering to the target base station if the mobile terminal is located within the multi-zone registration area.

17. The method of claim 16, further comprising, handing off from the present base station to the target base station and registering to the target base station if the mobile terminal is not located within the multi-zone registration area.
